(19) United States
(12) Patent Application Publication
(10) Pub. No.: US 2026/0072927 A1
(43) Pub. Date: Mar. 12, 2026

(54) PLANT INFORMATION DISPLAY METHOD AND APPARATUS, AND COMPUTER-READABLE STORAGE MEDIUM

(71) Applicant: Hangzhou Ruisheng Software Co., Ltd., Zhejiang (CN)

(72) Inventors: Qingsong Xu, Zhejiang (CN); Qing Li, Zhejiang (CN)

(73) Assignee: Hangzhou Ruisheng Software Co., Ltd., Zhejiang (CN)

(21) Appl. No.: 19/106,210

(22) PCT Filed: Jul. 26, 2023
(86) PCT No.: PCT/CN2023/109328

§ 371 Date: Feb. 25, 2025

(30) Foreign Application Priority Data
Aug. 29, 2022 (CN) 202211039362.2

(51) Int. Cl. G06F 16/248; G06F 3/04842; G06F 16/2457

(52) U.S. Cl. CPC G06F 16/248; G06F 3/04842; G06F 16/2457

(57) ABSTRACT

The present disclosure provides a plant information display method, apparatus, and computer-readable storage medium, and relates to the technical field of information processing. The method comprises: in response to a user request, acquiring plant information; according to at least one of a user attribute and a plant attribute, determining a content module that needs to be displayed; and displaying the content module so as to present the plant information corresponding to the content module. One or a plurality of content modules are provided. When a plurality of content modules are provided, each content module corresponds to a portion of the plant information, a display sequence between each content module can be adjusted, and the display sequence comprises at least one of a position sequence and a time sequence of the content modules during a display process.

### TECHNICAL FIELD

The present disclosure relates to the technical field of information processing, and in particular to a plant information display method and apparatus, and a computer-readable storage medium.

### DESCRIPTION OF RELATED ART

With the improvement of living standards, people's requirements for their living environment are becoming higher, and plants are always used to adjust the living environment indoors and outdoors.

When faced with unfamiliar plants or caring for plants, people often want to know relevant information about the plants, such as plant types, plant care information, interesting facts about the plants, and so on.

### SUMMARY

The inventors have noticed that in the related art, when relevant information about plants is displayed, it is often presented to users in the form of large blocks of text. Users need to spend a considerable amount of time reading and digesting the information, so the efficiency of browsing plant information is low, resulting in poor user experience.

To solve the above-mentioned problem, the embodiments of this present disclosure propose the following solutions.

According to one aspect of the embodiments of the present disclosure, a plant information display method is provided, including: in response to a user request, acquiring plant information of a plant; according to at least one of a user attribute and a plant attribute, determining a content module that needs to be displayed; and displaying the content module, so as to display the plant information corresponding to the content module, where one or a plurality of content modules are provided, and when a plurality of content modules are provided, each content module corresponds to a portion of the plant information, a display sequence between each content module can be adjusted, and the display sequence includes at least one of a position sequence and a time sequence of the content modules during a display process.

According to another aspect of the embodiments of the present disclosure, a plant information display method is provided, including: acquiring plant information of a target plant, where the plant information includes one or a plurality of content modules divided according to information content, and each content module has a name indicating a content topic of the content module; displaying the names of the one or plurality of content modules in a first region of a display page; and in response to receiving an operation associated with a first content module among the one or plurality of content modules, displaying information included in the first content module in the display page.

According to still another aspect of the embodiments of the present disclosure, a plant information display apparatus is provided, including: an acquisition module, configured to acquire plant information of a plant in response to a user request; a determination module, configured to determine a content module that needs to be displayed according to at least one of a user attribute and a plant attribute; and a display module, configured to display the content module, so as to display the plant information corresponding to the content module, where one or a plurality of content modules are provided, each content module corresponds to a portion of the plant information, and when a plurality of content modules are provided, a display sequence between each content module can be adjusted.

According to yet another aspect of the embodiments of the present disclosure, a plant information display apparatus is provided, including: an acquisition module, configured to acquire plant information of a target plant, where the plant information includes one or a plurality of content modules divided according to information content, and each content module has a name indicating a content topic of the content module; a display module, configured to display the names of the one or plurality of content modules in a first region of a display page; and in response to receiving an operation associated with a first content module among the one or plurality of content modules, displaying information included in the first content module in the display page.

According to yet another aspect of the embodiments of the present disclosure, a plant information display apparatus is provided, including: a memory; and a processor coupled to the memory, wherein the processor is configured to execute the method according to any one of the foregoing embodiments based on a command stored in the memory.

According to yet another aspect of the embodiments of the present disclosure, a computer-readable storage medium including a computer program instruction is provided, where when being executed by a processor, the computer program instruction implements the method of any one of the foregoing embodiments.

According to yet another aspect of the embodiments of the present disclosure, a computer program product including a computer program is provided, where when being executed by a processor, the computer program implements the method of any one of the foregoing embodiments.

The technical solutions of the present disclosure are further described in detail in combination with the accompanying drawings and embodiments.

### DESCRIPTION OF THE DRAWINGS

To make the technical solutions provided in the embodiments of the present disclosure or the related art more clearly illustrated, several accompanying drawings required by the embodiments or the related art for description are briefly introduced as follows. Obviously, the drawings in the following description are merely some embodiments of the present disclosure, and for a person having ordinary skill in the art, other drawings can be obtained based on these drawings without an inventive effort.

FIG. 1 is a schematic flow chart of a plant information display method according to some embodiments of the present disclosure.

FIG. 2, FIG. 3A, and FIG. 3B are schematic views of display images provided by an application program of the method according to some embodiments of the present disclosure.

FIG. 4 is a schematic flow chart of determining a content module that needs to be displayed in the plant information display method according to some embodiments of the present disclosure.

FIG. 5 is a schematic view of a display image provided by the application program of the method according to some embodiments of the present disclosure.

FIG. 6 is a schematic view of a second page in the plant information display method according to some embodiments of the present disclosure.

FIG. 7 to FIG. 9 are schematic views of interactive questionnaires according to some embodiments of the present disclosure.

FIG. 10 to FIG. 11 are schematic views of a configuration profile of user attributes according to some embodiments of the present disclosure.

FIG. 12 is a schematic flow chart of a plant information display method according to some other embodiments of the present disclosure.

FIG. 13 is a schematic view of a display image provided by the application program of the method according to some embodiments of the present disclosure.

FIG. 14 is a schematic structural view of a plant information display apparatus according to some embodiments of the present disclosure.

FIG. 15 is a schematic structural view of a plant information display apparatus according to some other embodiments of the present disclosure.

FIG. 16 is a schematic structural view of a plant information display apparatus according to still some embodiments of the present disclosure.

### DESCRIPTION OF THE EMBODIMENTS

Description will now be made in detail to clearly and completely present preferred embodiments of the present disclosure, examples of which are illustrated in the accompanying drawings. Nevertheless, the disclosed embodiments are merely part of the embodiments of the present disclosure, not all the embodiments. Based on the embodiments of the present disclosure, all other embodiments obtained by a person having ordinary skill in the art without making any inventive effort fall within the scope that the present disclosure seeks to protect.

The relative arrangement of the components and steps, numerical expressions, and numerical values set forth in these embodiments do not limit the scope of the present disclosure unless specifically stated otherwise.

Meanwhile, it should be understood that, for the convenience of description, the dimensions of various parts shown in the accompanying drawings are not drawn in an actual proportional relationship.

Techniques, methods, and apparatuses known to a person having ordinary skill in the art may not be discussed in detail, but where appropriate, such techniques, methods, and apparatuses should be considered part of the specification.

In all examples shown and discussed herein, any specific value should be construed as illustrative only and not as limiting. Accordingly, other examples of exemplary embodiments may have different values.

It should be noted that similar numerals and letters refer to similar items in the following figures. Therefore, once an element is defined in one figure, no further discussion of the element is required in subsequent figures.

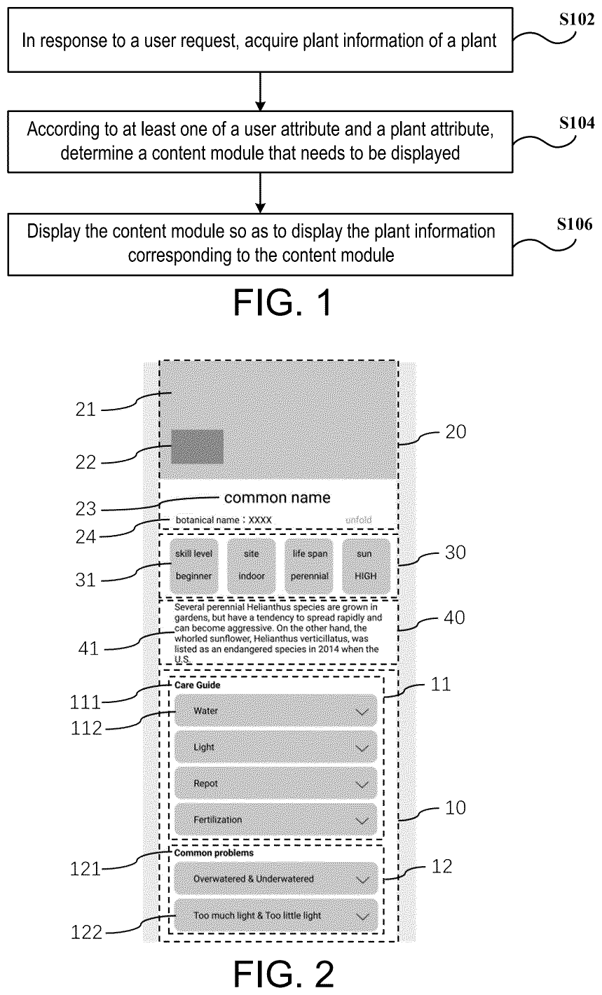

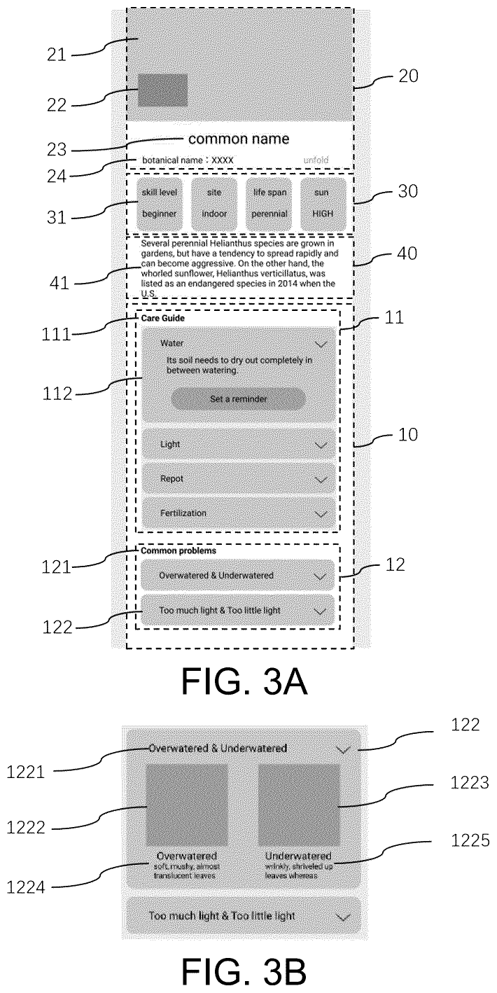

FIG. 1 is a schematic flow chart of a plant information display method according to some embodiments of the present disclosure. FIG. 2, FIG. 3A, and FIG. 3B are schematic views of display images provided by an application program of the method according to some embodiments of the present disclosure.

The plant information display method shown in FIG. 1 may be executed by an application program. The application program may be installed on an electronic apparatus such as a computer, a mobile phone, etc.

In a specific example, a user may input a plant image into the application program. The application program may, according to the method shown in FIG. 1, identify the plant image, acquire plant information based on an identification result, and finally display to a user the display images as shown in FIG. 2, FIG. 3A and FIG. 3B, so that the user may learn about the plant information.

In step S102, in response to a user request, plant information of a plant is acquired.

The user request includes at least one of an identification request and a search request, for example. The identification request, for example, is a request sent when the user wants to identify a target plant, and may carry a plant image taken by the user. The search request, for example, is a request sent when the user wants to learn about information related to a specific plant, and may carry the plant name.

The plant information, for example, may be pre-stored in a plant information database, so that in response to the user request, corresponding plant information may be acquired from the database. In some embodiments, the plant information database may store plant information such as a name of the plant, care information of the plant, an image of the plant, etc. The application program may, after identifying the name of the plant according to the user request, retrieve plant information such as the care information of the plant and the image of the plant from the plant information database using this name.

In step S104, according to at least one of a user attribute and a plant attribute, determining a content module that needs to be displayed. Content modules, for example, are divisions of the plant information, where content with a same topic in the plant information may be treated as one content module. For instance, the care information of the plant may be treated as one content module, and the image of the plant may also be treated as one content module.

Herein, one or a plurality of content modules are provided. When a plurality of content modules are provided, each content module corresponds to a portion of the plant information, and a display sequence between each content module can be adjusted. The display sequence includes at least one of a position sequence and a time sequence of the content modules during a display process. The position sequence, for example, is a top-down or left-right sequence of plural content modules on a same page. The time sequence, for example, is the sequence in which the content modules appear.

The user attribute may include, for example, at least one of skill level, Commitment level, address, scenario, demand, and nationality.

Herein, values of the skill level may include, for example, lacking skills, beginner, experienced, skilled, master, etc. Values of the identity level may include, for example, low, medium, high, etc. The address may include, for example, indoor, outdoor, wild, etc. Values of the scenario may include, for example, agriculture, decoration, diagnosis, weeds, identification, eating, care, learning, etc. Values of the demand may include, for example, a reminder and a purchase suggestion, etc. How to determine the user attribute is introduced in combination with some embodiments in the following paragraphs.

The plant attribute includes at least one of plant type, species, Plant Developmental Stages, state, care, location, and crop type.

Herein, values of the plant type may include, for example, indoor plants, garden plants, wild plants, cut flowers, weeds, poisonous plants, invasive plants, etc. In some embodiments, values of species may include vegetables, fruits, cacti, shrubs, trees, bulbs, vines, conifers, ferns, herbs, ornamental grasses, roses, palms-cycads, bamboos, aquatic plants, orchids, etc. In other embodiments, the values of the species may be a category in botanical classification, with its classification level being species (including subspecies), genus (including subgenus), or other levels. Values of Plant Developmental Stages may include perennial, biennial, annual. Values of state may include seed (sowing), flowering, harvesting, etc. Values of plant care may include water, fertilization, repot, mist, rotation, sun, soil, etc., where water may further include 3 levels: low, moderate, and high. Values of location may include garden, balcony, indoor, greenhouse, mixed type, etc. Values of the crop type may include those planted on land, those planted on raised ground (including mounds, bottomless, and plaza), those planted in pots isolated from the ground.

As some implementations, the content module that needs to be displayed may be determined according to the user attribute. As other implementations, the content module that needs to be displayed may be determined according to the plant attribute. As yet other implementations, the content module that needs to be displayed may be determined according to both the user attribute and the plant attribute.

For instance, when the species in the plant attribute indicates that the plant is a vegetable or fruit, the content modules such as care, nutrition, and sowing may be determined as the content modules that need to be displayed. As another example, when the species in the plant attribute indicates that the plant is a horticultural plant, a horticultural design content module may be determined as the content module that needs to be displayed.

In some embodiments, the content module that needs to be displayed may be determined according to at least one of the user attribute and the plant attribute and an environment attribute.

Herein, the environmental attribute includes at least one of time information, climate information of a location of the plant, temperature information, humidity information, and illumination information. Herein, values of the time information may be, for example, the current season at the plant's location, and values of the climate information of the plant's location may be, for example, the climate zone to which the plant's location belongs.

As some implementations, the content module that needs to be displayed may be determined according to both the user attribute and the environmental attribute. As other implementations, the content module that needs to be displayed may be determined according to both the plant attribute and the environmental attribute. As yet other implementations, the content module that needs to be displayed may be determined according to all three of the user attribute, the plant attribute, and the environmental attribute.

How to determine the content module that needs to be displayed is to be introduced in combination with some embodiments in the following paragraphs.

In step S106, the content module is displayed, so as to display the plant information corresponding to the content module.

It should be understood that the display images shown in FIG. 2, FIG. 3A, and FIG. 3B are only used for exemplary description of one or more embodiments of the present disclosure, and are not intended to limit the scope of the present disclosure.

As shown in FIG. 2, in some embodiments, the display image may include a region 10 for displaying the content modules. The region 10 may be divided into a plurality of regions, with each region used to display one content module. For instance, a region 11 is used to display a “Care Guide” content module, and a region 12 is used to display a “Common problems” content module.

The region 11 may include a name 111 of the content module and one or a plurality of submodules 112 of that content module. Displaying the name 111 of the content module helps a user establish an understanding of a topic of that content module. One or plural submodules 112 may include water, light, repot, fertilization, and other submodules. These submodules are generated by dividing the information content of the Care Guide content module. Each submodule has a name indicating the content topic of that submodule, with names such as “Water”, “Light”, “Repot”, and “Fertilization”, respectively.

The region where the submodule 112 is located may be an operable region. In response to receiving an operation associated with the submodule 112, information included in the submodule 112 may be displayed in a display page. For instance, after the user taps “Water”, the display page may change as shown in FIG. 3A. Herein, the submodule 112 corresponding to “Water” displays detailed information about this care measure-for instance, “Its soil needs to dry out completely between watering”. In addition, a “Set a reminder” button may be displayed together in the submodule 112. After the user taps the “Set a reminder” button, the application program may remind the user to water according to the user's needs or predetermined rules.

The region 12 may include a name 121 of the content module and one or a plurality of submodules 122. In the specific examples shown in FIG. 2 and FIG. 3A, each submodule in the “Common problems” content module is set to include multiple related common problems, such as two common problems with a comparative relationship. As shown in the figure, one or more submodules 122 may include submodules like “Overwatered & Underwatered”, “Too much light & Too little light”, etc. Although not presented in the form of questions, it shall be understood that the content shown represents questions such as “What is the plant's appearance when overwatered?” or “What are the effects of overwatering on this plant?”, etc. This setup allows the user to understand the common problems covered by the submodule more intuitively and clearly. For instance, in response to receiving an operation associated with “Too much light & Too little light” (such as tapping the region of this submodule), the display page may show one or more representative images of the plant in both too much and too little light situations. This allows the user to visually understand the plant's appearance in cases of too much or too little light, or to judge for him/herself whether the current state of the target plant indicates too much light, too little light, or generally appropriate light based on the displayed images.

One specific example may be as shown in FIG. 3B. When the user taps the region of the submodule 112 corresponding to “Overwatered & Underwatered”, this submodule may change to as what is shown in FIG. 3B. Herein, the submodule 112 corresponding to “Overwatered & Underwatered” displays the name of the submodule 1221, a representative image 1222 of the plant in an overwatered situation, a representative image 1223 of the plant in an underwatered situation, a description 1224 of the plant's state in an overwatered situation, and a description 1225 of the plant's state in an underwatered situation.

It should be understood that the content included in the submodule is not limited to images, but may also be text, video, audio, etc. Further, in other embodiments, each submodule in the “Common problems”content module may be set to include only a single common problem.

In some embodiments, the display image may also include a region 20, and the region 20 is used to show basic information of the plant. The region 20 may include a representative image 21 of the plant, an image 22 of the plant taken by the user for this identification, a common name 23 of the plant, and a botanical name 24 of the plant, etc.

In some embodiments, the display image may also include a region 30 for displaying labels of the plant information. The region 30 may include at least one label 31. The labels may be determined according to the user attribute and the plant attribute.

As some implementations, the labels may include at least one of the user's value on user attribute or the plant's value on plant attribute. For instance, a label 21 may be “skill level: beginner”, “site: indoor”, “Plant Developmental Stages: perennial”, “sun: High”, etc.

By displaying the labels, the user may quickly understand key information related to the plant and him/herself, and user experience is thereby improved.

In addition, the use of labels is also beneficial for summarizing and categorizing the plant information according to the labels, and in this way, related plants may be found based on the labels later. For instance, when the user searches for a particular plant and a “poisonousness” label appears, the user may perform a specific operation on this label, so as to learn about other plants that also have the “poisonousness” label, and the user is provided with more enriched and comprehensive plant information in this way.

In addition, in the display image that includes the region 30 for displaying the labels of the plant information, the user may operate on an undesired label, so as to close the display of the content module corresponding to that label. In some embodiments, in response to receiving an operation associated with a label, it may be determined whether all labels included in the content module corresponding to the label are operated (where one content module may have one or a plurality of labels). Further, in response to all labels of the content module corresponding to the label being operated, the display of the corresponding content module in the region 10 is closed. It should be understood that in these embodiments, the operation and the aforementioned operation on the labels to learn about other plants that also have that label shall be two different predefined operations. In a specific example, the user may tap a specific label to view other plants that also have that label, and long-press a specific label to close the display of the content module corresponding to that label.

For instance, if the display page shows three labels: “water: low watering”, “sun: High”, and “skill level: beginner”, herein, “water: low watering” and “sun: High” correspond to the care content module, while “skill level: beginner”corresponds to the skill content module.

When receiving an operation related to “water: low watering” (referring to the operation intended to close the display of the content module corresponding to this label), it is determined that whether all labels included in the care content module have been operated on, which means it also needs to determine if “sun: High” has been operated on in this way. If “sun: High” has also been operated on, then the display of the care content module may be closed, meaning the care content module is not displayed. Correspondingly, the display page may show other content modules that the user may be more interested in, which can help display content modules that the user may be more interested in at more prominent positions with the user's active participation. For instance, the user may be able to see interesting content modules without the need to perform scrolling or page-turning operations, so efficiency of the user browsing the plant information is improved, and the user experience is thereby enhanced.

In some embodiments, the display image may also include a region 40, and the region 40 may include a text message 41 that provides an overall description of the plant.

In the above embodiments, determining the content module that needs to be displayed based on at least one of the user attribute and the plant attribute facilitates personalized display of plant information, and the user experience is thereby improved. In addition, displaying the plant information through the content modules, compared to the approach of displaying the plant information through long paragraphs of text, is more concise and clear, so that the efficiency of the user browsing the plant information is improved, and the user experience is also enhanced.

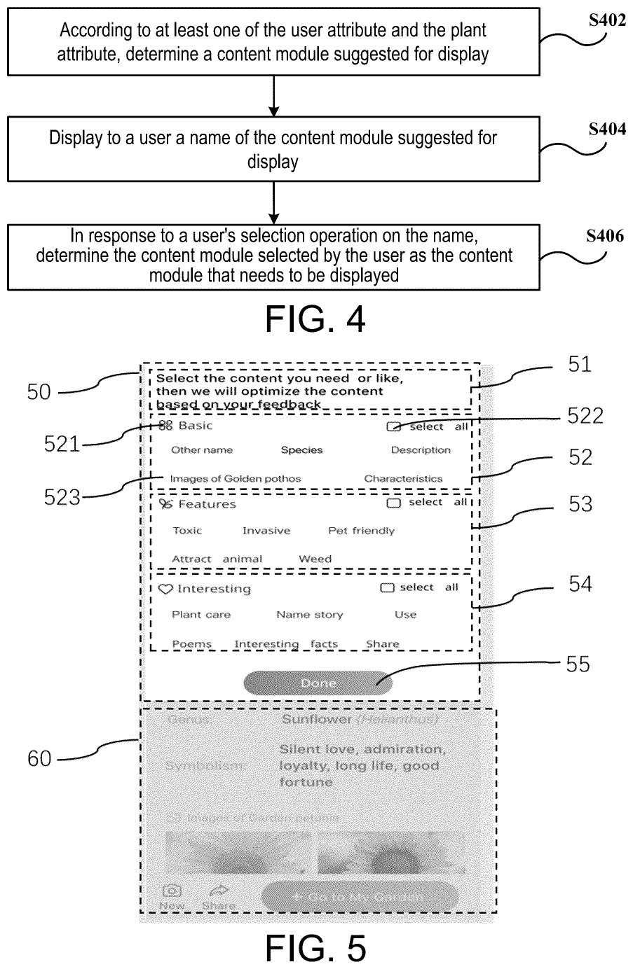

FIG. 4 is a schematic flow chart of determining a content module that needs to be displayed according to some embodiments of the present disclosure.

In step S402, a content module suggested for display is determined according to at least one of the user attribute and the plant attribute.

The content module suggested for display includes, for example, at least one of a basic type-content module, a feature-type content module, and an interest-type content module.

Herein, the basic-type content module includes, for example, at least one of other name, species, description, images, and characteristics. The feature-type content module includes, for example, at least one of toxic, whether it is an invasive species, whether it is pet-friendly, whether it attracts animals, and whether it is a weed. The interest-type content module includes, for example, at least one of care, name story, use, related poems, interesting facts, and share.

As some implementations, the content module suggested for display may be determined according to the user attribute. For instance, when the user attribute indicates that the user is a “beginner”, care may be determined as a content module suggested for display.

As some other implementations, the content module suggested for display may be determined according to the plant attributes. For instance, when the plant attribute includes species, the content module suggested for display may be determined based on the species. As yet some other implementations, the content module suggested for display may be determined based on both the user attribute and the plant attribute. As still some other implementations, the content module suggested for display may be determined based on at least one of the user attribute and the plant attribute as well as an environmental attribute.

In step S404, the name of the content module suggested for display is displayed to the user. Herein, the name is used to indicate the content topic of the respective content module.

For instance, FIG. 5 is a schematic view of a display image provided by the application program of the method according to some embodiments of the present disclosure.

As shown in FIG. 5, names of the content modules suggested for display such as “other name”, “species”, “description”, “images”, etc. may be displayed to the user in a region 50.

In step S406, in response to a user's selection operation on the name of the content module suggested for display, the content module selected by the user is determined as the content module that needs to be displayed.

For instance, if the user selects the 3 names of “other name”, “species”, and “description”, then the 3 content modules of other name, species, and description are determined as the content modules that need to be displayed, and these 3 content modules are displayed subsequently.

The following paragraphs further introduce how to determine the content module that needs to be displayed in response to the user's selection operation on the name of the content module suggested for display in combination with some embodiments.

In the above embodiments, the content module suggested for display is first determined based on at least one of the user attribute and the plant attributes, and then the content module that needs to be displayed is determined according to the user's selection. This approach allows for fully incorporating user needs on the basis of personalized display of content modules, so the user experience is further improved.

In some embodiments, when the user does not perform a selection operation on the name of the content module suggested for display, the content module suggested for display is determined as the content module that needs to be displayed.

In some embodiments, the content modules include multiple modules. In this situation, a display sequence is determined according to at least one of the user attribute and the plant attribute, and the content modules are then displayed according to the display sequence.

As some implementations, the display sequence may be determined according to the user attribute. For instance, when the skill level in the user's attribute is beginner, it may be assumed that this user is more concerned about the care content module. Therefore, the care content module may be set as the first content module to be displayed among the multiple content modules.

For another instance, when the skill level in the user attributes is beginner, and the plant attribute indicate that the plant is not easy to survive and not suitable for a beginner to care, the content modules that need to be displayed may include a reminder content module. The content of the reminder content module may be, for example, “This plant is not easy to survive and is not suitable for a beginner to care”, and the reminder content module may serve as the first content module to be displayed among the multiple content modules.

As some implementations, the display sequence may be determined according to the plant attribute. For instance, if the species in the plant attribute indicates that the plant is a weed, then the content module about whether it is a weed may be set as the first content module to be displayed, so that the user can immediately know that the plant is a weed and learn how to remove the weed. Further, both the display sequence and the display content may be determined according to the plant attribute. For instance, if the species in the plant attribute indicates that the plant is a vegetable, then the care, nutrition, and sowing content modules may be set as the content modules that need to be displayed, and the nutrition content module may be set as the first content module to be displayed.

As some implementations, the display sequence may be determined according to both the user attribute and the plant attribute. Further, both the display sequence and the display content may be determined together according to the user attribute and the plant attribute.

As some implementations, the display sequence may be determined according to at least one of the user attribute and the plant attributes as well as the environmental attribute. Further, both the display sequence and the display content may be determined together according to at least one of the user attribute and the plant attribute as well as the environmental attribute.

In the above embodiments, the use of the user attribute and/or the plant attribute as the basis for determining the display sequence makes the display sequence of the plant information more reasonable. The user is allowed to see the information he/she is most concerned about first by determining the display sequence according to the user attribute, so the user experience is further improved. The display of key information about the plant is prioritized by determining the display sequence according to the plant attributes. Using both the user attribute and the plant attribute as the basis for determining the display sequence can take into account both the user's preferences and prioritize the display of key information about the plant.

In addition, determining both the display sequence and the display content together may be beneficial for making the display of the plant information more reasonable.

In some embodiments, according to at least one of the user attribute and the plant attribute, an importance level of the content module that needs to be displayed is determined. The display sequence is determined according to the importance level, and the content module that needs to be displayed is displayed according to the display sequence.

For instance, the importance level of the content modules may be divided into level 1, level 2, and level 3. If the content modules that need to be displayed are other name, care, and interesting facts, according to the user attribute and/or the plant attribute, it is determined that the importance level of other name is level 1, the importance level of interesting facts is level 2, and the importance level of care is level 3. The display sequence may therefore be determined as displaying care first, then displaying interesting facts, and finally displaying other name.

In some embodiments, before the content modules are displayed, according to at least one of the user attribute and the plant attribute, the importance level of the content module that needs to be displayed is determined. A size of a display region corresponding to the content module that needs to be displayed is determined according to the importance level.

For instance, the importance level of the content modules may be divided into level 1, level 2, and level 3, where level 1 corresponds to the smallest display region, and level 3 corresponds to the largest display region. If the content modules that need to be displayed are other name, care, and interesting facts and according to the user attribute and/or the plant attribute, it is determined that the importance level of other name is level 1, the importance level of interesting facts is level 2, and the importance level of care is level 3. The display region corresponding to care is then the largest, the display region corresponding to interesting facts is the second largest, and the display region corresponding to other name is the smallest.

In the above embodiments, the sizes of the display regions for the content modules are determined according to the importance level, with larger display regions for higher importance levels and smaller display regions for lower importance levels. Accordingly, the content modules with higher importance levels may be displayed in more detail, while content modules with lower importance levels are displayed more concisely. Through this display approach, with appropriate levels of detail, the user experience may be further improved.

As some implementations, before the content modules are displayed, the importance level of the content module that needs to be displayed may be determined according to at least one of the user attribute and the plant attribute as well as the environmental attribute.

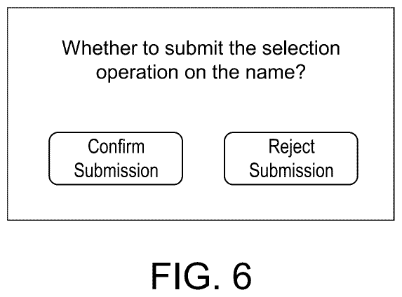

FIG. 6 is a schematic view of a second page in the plant information display method according to some embodiments of the present disclosure.

The following further introduces how to determine the content module that needs to be displayed in response to the user's selection operation on the name of the content module suggested for display in combination with FIG. 5 and FIG. 6.

As shown in FIG. 5, a display image may include a region 50 for displaying the names of the content modules to the user. The region 50 may be divided into multiple regions, with each region used to display the names of one category of content modules. For instance, a region 52 is used to display the name of the basic-type content module, a region 53 is used to display the name of the feature-type content module, and a region 54 is used to display the name of the interest-type content module.

In some embodiments, the region 50 may also include description 51 of the selection operation to inform the user how he/she shall operate. The description of the selection operation may be, for example, “Select the content you need or like, and we will optimize the content based on your feedback”.

The region 52 may include a category name 521 for a category of content modules, a select all button 522, and a name 523 of each content module belonging to that category. The structure and layout of the regions 53 and 54 are similar to the region 52, so description thereof is not repeated herein.

In some embodiments, a select all button corresponding to each category of content modules in the content module suggested for display is displayed to the user. In response to the user's selection operation on the name of the content module suggested for display and a user's selection operation on the select all button, when the user does not select all content modules in a category of content modules corresponding to the select all button, it is determined that the user selects all content modules under a category of content modules corresponding to the select all button.

For instance, if the user selects “other name”, “species”, and the select all button 522 for the basic-type content module, it is determined that the user selects all the content modules under the basic-type content module. That is, it is determined that the user selects the five content modules: other name, species, description, images, and characteristics, and subsequently, these five content modules are also be displayed.

In response to the user's selection operation on the name of the content module suggested for display and the user's selection operation on the select all button, when the user has already selected a category of content modules corresponding to the select all button, it is determined that the user does not select all content modules under the category corresponding to the select all button.

For instance, if the user selects “other name”, “species”, “description”, “images”, “characteristics”, “toxic”, “whether it is an invasive species”, and the select all button 522 for the basic-type content module, since other name, species, description, images, and characteristics belong to the basic-type content module, while toxic and whether it is an invasive species do not belong to the basic-type content module, it may be determined that the user does not select the five modules of other name, species, description, images, and characteristics. Subsequently, only the two content modules of toxic and whether it is an invasive species are displayed.

In the above embodiments, by arranging the select all button, the user is allowed to quickly select the content modules, so the user experience is improved.

In some embodiments, the name of the content module suggested for display is displayed to the user in a first page. In response to the user's selection operation on the name of the content module suggested for display, the first page may be closed.

The first page may be, for example, the region 50 shown in FIG. 5. The first page may be a pop-up window, or it may be another display page that slides away or completely covers the current page.

In some embodiments, the first page also includes a Done button 55. In this situation, the Done button 55 is presented to the user. In response to the user's selection operation on the name of the content module suggested for display and the selection operation on the Done button 55, the first page is closed.

For instance, in the embodiment shown in FIG. 5, in response to the user's selection operation on “other name”, “species”, and the Done button 55, the first page may be closed.

In some embodiments, after the user performs a selection operation on the name of the suggested content module for display, the user is allowed to select the Done button 55.

In some embodiments, when the user does not perform a selection operation on the name of the content module suggested for display, the region containing the Done button 55 is non-interactive, and the user may not select the Done button 55.

In some embodiments, as shown in FIG. 5, a blank region 60 may be displayed to the user, and the blank region 60 may be displayed simultaneously with the first page. The blank region may be, for example, a semi-transparent interface as shown in FIG. 5, or it may be an opaque interface.

When the user performs the selection operation on the name of the content module suggested for display, does not perform a selection operation on the Done button 55, and taps the blank region 60, a second page as shown in FIG. 6 is displayed to the user, and the second page includes a prompt message to confirm with the user whether to submit the selection operation on the name, a confirm submission button, and a reject submission button.

In response to a user's selection operation on the confirm submission button, the second page may be closed. In response to a user's selection operation on the reject submission button, the second page may be closed, and the first page may be displayed.

For instance, if the user selects “other name”, does not select the Done button 55, and then taps any part of the blank region, the second page as shown in FIG. 6 may be displayed to the user at this point. If the user then selects the confirm submission button on the second page, the second page may be closed, and the content module of other name may be displayed to the user afterwards. If the user selects the reject submission button, the second page may be closed and the first page may be displayed to the user, and the user may then perform operations on the first page.

In some embodiments, when the user does not perform a selection operation on the name of the content module suggested for display and performs a tap operation on the blank region, the first page is closed.

In some embodiments, it is determined whether the user has sent a predetermined number of user requests. If the user has sent the predetermined number of user requests, the name of the content module suggested for display is displayed to the user.

For instance, the predetermined number may be set to 4, and when the user sends the 5^{th} identification request, as the user has already sent the predetermined number of user requests, the first page as shown in FIG. 5 may be displayed to the user, allowing the user to select the names of the content modules suggested for display.

In some embodiments, when the user has sent the predetermined number of user requests and the user performs a downward swipe operation, the name of the content module suggested for display may be shown to the user.

For instance, the predetermined number may be set to 4, and when the user sends the 5^{th} recognition request and performs a downward swipe operation, the first page as shown in FIG. 5 may be displayed to the user, allowing the user to select the names of the suggested content modules for display.

How to determine the user attribute is introduced in combination with some embodiments in the following paragraphs.

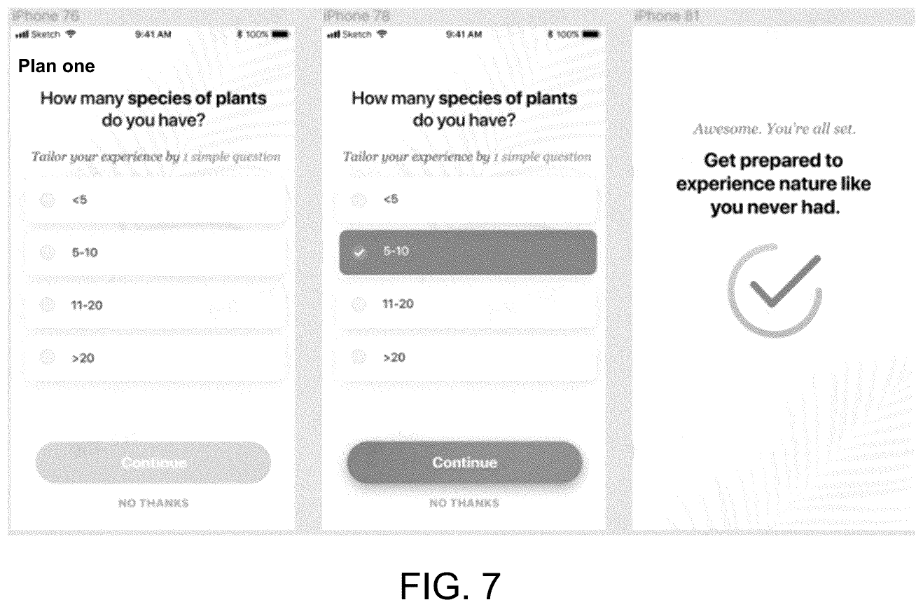

FIG. 7 to FIG. 9 are schematic views of interactive questionnaires according to some embodiments of the present disclosure.

In some embodiments, the user attribute is determined based on at least one of an interactive questionnaire and historical operation data of the user recorded by the system.

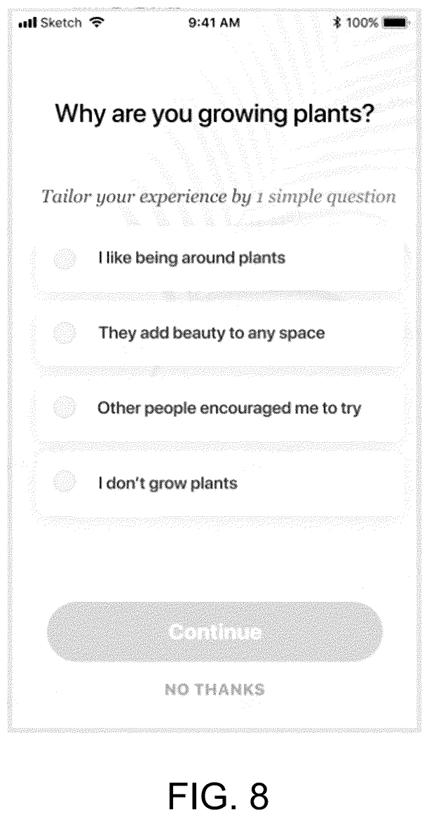

As some implementations, the user attribute may be determined based on interactive questionnaires. For instance, interactive questionnaires as shown in FIG. 7 or FIG. 8may be used to determine the user attribute through the user's answers to questions.

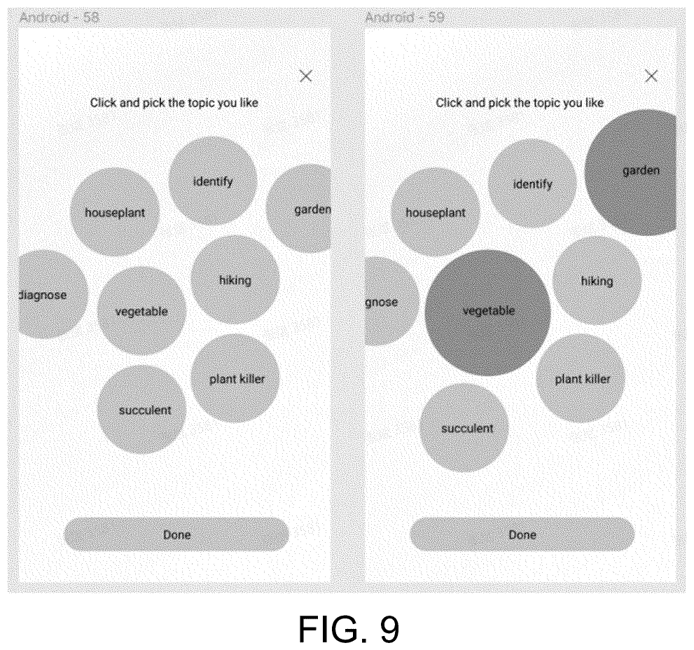

As another example, an interactive questionnaire as shown in FIG. 9 may be used to display some values of the user attribute and the plant attribute to the user. The values may include “indoor plants”, “identify”, “diagnosis”, etc., and the user attribute may then be determined through the user's selection results of these values. The interactive questionnaire shown in FIG. 9 may be used for a launch screen interface of a new user.

As some other implementations, the user attribute may be determined based on the user's historical operation data recorded by the system. The historical operation data may include at least one of the user's plant identification result, the number of identifications made by the user, the types of plants owned by the user, the user's country of residence, and the user's selection operations on the names of the content modules.

In some embodiments, a configuration profile of the user attribute may be displayed to the user, and the user may be allowed to modify the user attribute. The modification may include at least one of adding, deleting, and changing.

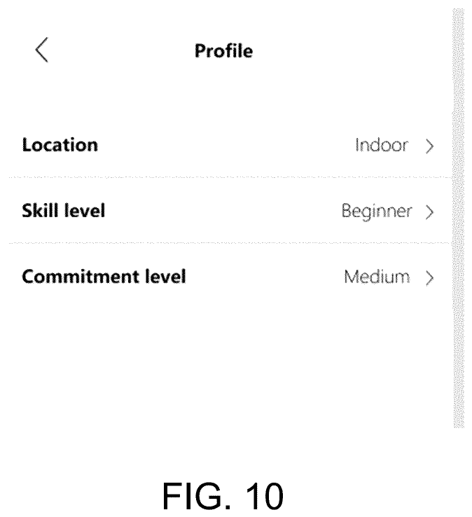

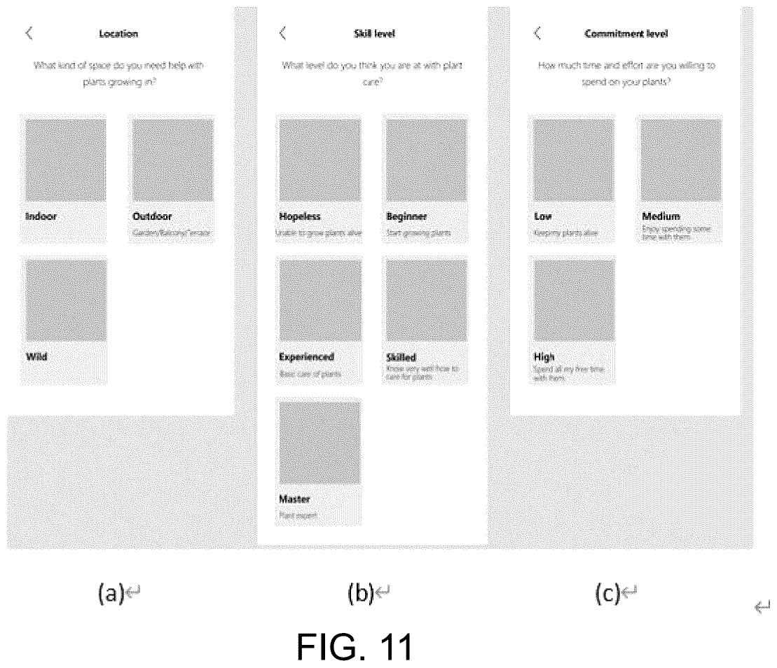

FIG. 10 to FIG. 11 are schematic views of a configuration profile of user attributes according to some embodiments of the present disclosure.

As shown in FIG. 10, there are three types of user attributes in the configuration profile: Location, Skill level, and Commitment level, and the user's values for these three user attributes are: Indoor, Beginner, and Medium, respectively.

After the user taps Location, the display image shown in (a) of FIG. 11 appears. After the user taps the Skill level, the display image shown in (b) of FIG. 11 appears. After the user taps Commitment level, the display image shown in (c) of FIG. 11 appears. In the interface shown in FIG. 11, the user may modify the values of these three user attributes: Location, Skill level, and Commitment level. For instance, the user may change the value of Location to Outdoor.

In some embodiments, a functional path of an application program implementing the method of some embodiments of the present disclosure, an interaction way between the application program and the user, etc., may also be determined based on at least one of the user attribute and the plant attribute.

In some embodiments, a sample plan may also be set up for a user whose skill level value in the user attribute is beginner, to allow this type of user to care plants more easily. The effectiveness of this sample plan may then be evaluated through methods such as questionnaire surveys or identifying the user's care results.

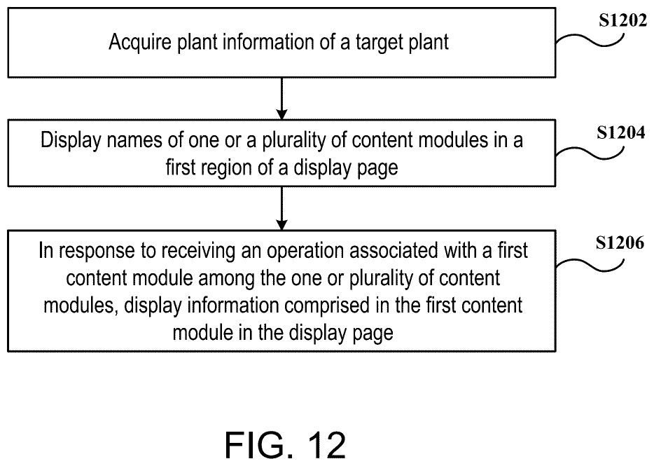

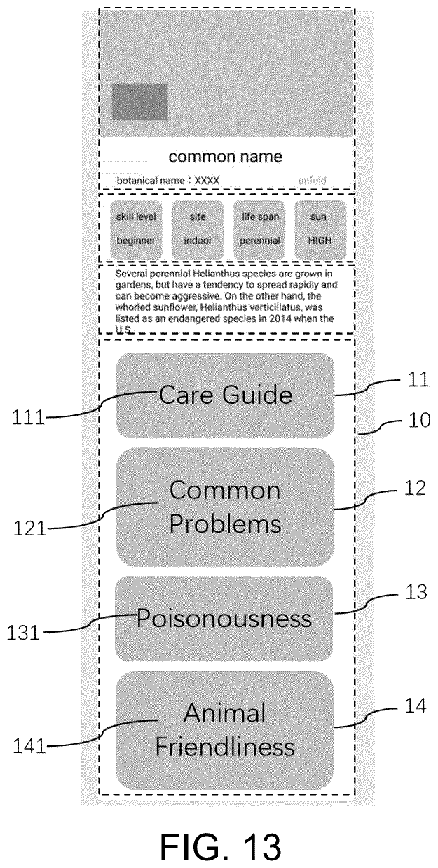

FIG. 12 is a schematic flow chart of a plant information display method according to some other embodiments of the present disclosure. FIG. 13 is a schematic view of the display screen provided by the application program of the method according to some embodiments of the present disclosure.

The following description of the plant information display method according to some other embodiments of the present disclosure is provided together with FIG. 2, FIG. 12, and FIG. 13.

In step S1202, plant information of a target plant is acquired. Herein, the plant information includes one or a plurality of content modules divided according to information content, and each content module has a name indicating a content topic of the content module.

For instance, the plant information may be divided into one or more content modules such as other name, species, description, images, characteristics, toxic, whether it is an invasive species, whether it is pet-friendly, whether it attracts animals, whether it is a weed, care, name story, use, related poems, interesting facts, and share. The name of each content module may correspondingly be “other name”, “species”, “description”, “images”, “characteristics”, and so on for multiple content modules.

In step S1204, the names of the one or plurality of content modules are displayed in a first region of a display page.

For instance, as shown in FIG. 13, the region 10 may include the region 11, the region 12, a region 13, and a region 14, with each region corresponding to one content module. The region 11 displays the name 111 “Care Guide” of its corresponding content module, the region 12 displays the name 121 “Common Problems” of its corresponding content module, the region 13 displays the name 131 “Poisonousness” of its corresponding content module, and the region 14 displays the name 141 “Animal Friendliness” of its corresponding content module.

In step S1206, in response to receiving an operation associated with a first content module among the one or plurality of content modules, information included in the first content module is displayed in the display page.

The operation associated with the first content module may be an operation on the display region associated with the first content module. For instance, the user may tap the display region associated with the first content module, and after tapping, the information included in the first content module may be displayed on the display page.

In a specific example, as shown in FIG. 13, after the user performs a tap operation on the region 11 corresponding to the “Care Guide” content module, the display image may change to that shown in FIG. 2, i.e., one or more submodules 112 included in its corresponding content module are displayed in the region 11. In this example, the information included in the Care Guide content module is displayed in the region 11 through the way of displaying submodules. It should be understood that in other examples, the region 11 may also display the information included in the Care Guide content module by directly displaying the text, images, audio and video, and other content included in the content module (rather than through the way of displaying submodules).

In the above embodiments, the information content is pre-divided into content modules, facilitating the subsequent modular display of the plant information. Responding to the user operation to display the information of the content module allows the user to select the displayed information on his/her own, so the efficiency of user browsing the plant information is improved, and the user experience is thus enhanced.

In some embodiments, each content module also has one or a plurality of labels associated with the information content of the content module.

In this situation, all labels corresponding to one or plurality of content modules are displayed in the second region of the display page, where the position arrangement of the second region in the display page is more prioritized than the first region.

The second region is, for example, the region 30 in FIG. 2. The second region includes the label 31, and for the description of the region 30 and the label 31, please refer to the previous description of FIG. 2.

In the above embodiments, the labels associated with the information content of the content modules are displayed in the second region, and the position arrangement of the second region in the display page is more prioritized than the first region. The user first sees the labels related to the plant information in this way, so the user can quickly understand the key information about the plant, and the user experience is thereby enhanced.

In some embodiments, in response to receiving an operation associated with a first label among the labels, it is determined whether all labels included in the content module corresponding to the first label are operated. In response to all labels of the content module corresponding to the first label being operated, the display of the corresponding content module in the first region is closed. The operation function of the first label may refer to the previous description of FIG. 12.

In some embodiments, the second content module among one or more content modules may include multiple submodules divided according to the information content, with each submodule having the name indicating the content topic of that submodule. In this situation, the names of the plurality of submodules in a region associated with the second content module are displayed in the first region. In response to receiving an operation associated with a first submodule among the plurality of submodules, information included in the first submodule is displayed in the display page. For the description of the submodules, please refer to the previous description of FIG. 2. Herein, the second content module and the first content module may be the same or different.

In the above embodiments, dividing the content module into submodules makes the display of the plant information clearer and more comprehensible. Further, it facilitates the user in selecting the submodules he/she wish to learn about, so the users'efficiency when browsing the plant information is improved, and user satisfaction is enhanced.

In some embodiments, according to at least one of the user attribute and the plant attribute, the plant information of the target plant is acquired. Personalized plant information display is thereby implemented in this way, and user satisfaction is thereby enhanced.

For instance, if the value of the user attribute indicates that the user is a beginner, then plant information mainly related to care may be acquired.

As another example, if the value of the plant attribute indicates that the plant is a vegetable, then plant information mainly related to care may be acquired.

In some embodiments, a plant information database may be pre-established, and the database stores plant information of a plurality of plants. The plant information of each plant includes a plurality of content modules divided according to information content. Each content module has a name indicating a content topic of the content module and one or a plurality of labels associated with the information content of the content module.

The plant information of the target plant is retrieved from the database according to species of the target plant. Herein, the species refers to a category of plant in botanical classification, which may be at the level of species (including subspecies), genus (including subgenus), or other levels.

One or a plurality of target labels are determined according to at least one of other plant attributes of the target plant and the user attribute.

For instance, if the plant attribute of the target plant is vegetable, then the target labels may be determined as “water: frequent watering”, “sun: strong”.

According to the one or plurality of target labels, one or a plurality content modules corresponding to the one or plurality target labels are acquired from the plant information of the plant, so as to acquire the plant information of the target plant.

For instance, when the target labels are “water: frequent watering” and “sun: strong”, the corresponding content module may be determined to be the care content module, so the plant information corresponding to the care content module is acquired. In the above embodiments, by pre-establishing the plant information database to store the plant information and the target labels, the efficiency of obtaining plant information for the target plant may be improved, and the user experience is thus enhanced.

Each embodiment in the specification is described in a progressive manner. Each embodiment focuses on its differences from other embodiments, and the same or similar parts among various embodiments may be referred to one another. As for a device embodiment, since it basically corresponds to the method embodiment, the description is relatively simple. For relevant details, please refer to the partial description of the method embodiment.

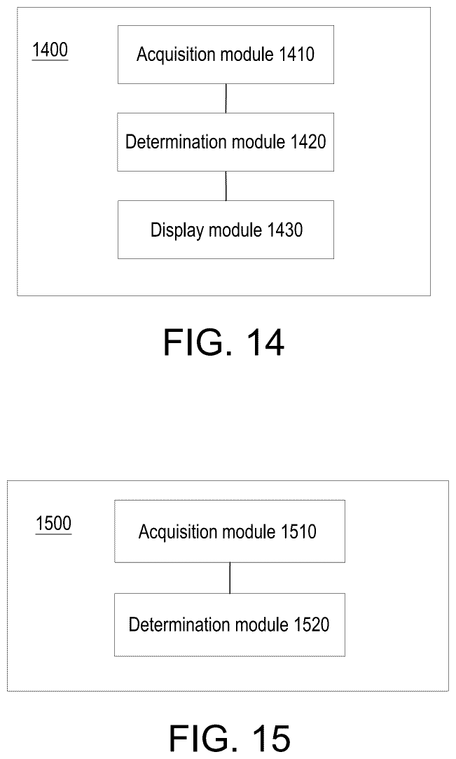

FIG. 14 is a schematic structural view of a plant information display apparatus according to some embodiments of the present disclosure.

As shown in FIG. 14, a plant information display apparatus 1400 includes an acquisition module 1410, a determination module 1420, and a display module 1430.

The acquisition module 1410 is configured to acquire plant information of a plant in response to a user request.

The determination module 1420 is configured to determine a content module that needs to be displayed according to at least one of a user attribute and a plant attribute.

The display module 1430 is configured to display the content module, so as to display the plant information corresponding to the content module. Herein, one or a plurality of content modules are provided, and each content module corresponds to a portion of the plant information. When a plurality of content modules are provided, a display sequence between each content module can be adjusted.

FIG. 15 is a schematic structural view of a plant information display apparatus according to some other embodiments of the present disclosure.

As shown in FIG. 15, a plant information display apparatus 1500 includes an acquisition module 1510 and a display module 1520.

The acquisition module 1510 is configured to acquire plant information of a target plant. Herein, the plant information includes one or a plurality of content modules divided according to information content, and each content module has a name indicating a content topic of the content module.

The display module is configured to display the names of the one or plurality of content modules in a first region of a display page. In response to receiving an operation associated with a first content module among the one or plurality of content modules, information included in the first content module is displayed in the display page.

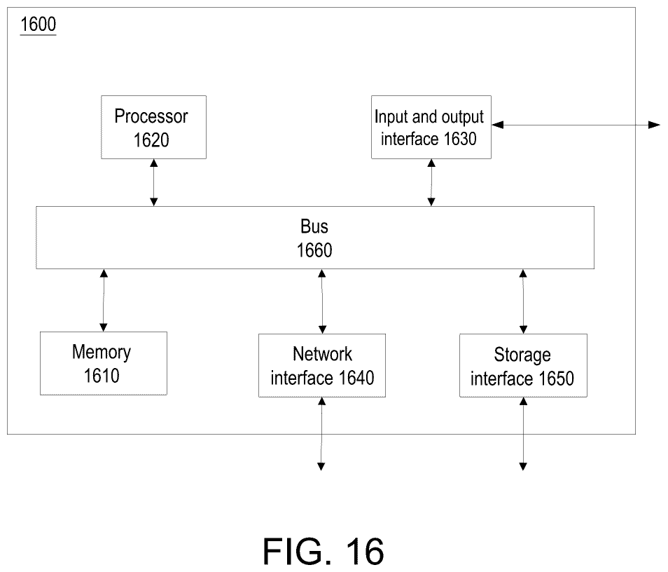

FIG. 16 is a schematic structural view of a plant information display apparatus according to still some embodiments of the present disclosure.

As shown in FIG. 16, a plant information display apparatus 1600 includes a memory 1610 and a processor 1620 coupled to the memory 1610. The processor 1620 is configured to execute the method according to any one of the foregoing embodiments based on a command stored in the memory 1610.

The memory 1610 may include, for example, a system memory, a fixed non-volatile storage medium, etc. The system memory may store, for example, an operating system, an application program, a boot loader, and other programs.

The plant information display apparatus 1600 may further include an input and output interface 1630, a network interface 1640, a storage interface 1650, and the like. These interfaces 1630, 1640, and 1650, the memory 1610, and the processor 1620 may be connected through a bus 1660, for example. The input and output interface 1630 provides a connection interface for input and output devices such as a monitor, a mouse, a keyboard, and a touch screen. The network interface 1640 provides a connection interface for various networked devices. The storage interface 1650 provides a connection interface for an external storage device such as a SD card and a USB disk.

An embodiment of the present disclosure further provides a computer-readable storage medium including a computer program instruction. The computer program instruction, when being executed by a processor, implements the method of any one of the foregoing embodiments.

An embodiment of the present disclosure further provides a computer program product including a computer program. Herein, the computer program, when being executed by a processor, implements the method of any one of the foregoing.

Various embodiments of the present disclosure have been described in detail so far. To avoid obscuring the concepts of the present disclosure, some details that are well known in the art have not been described. Based on the above description, a person having ordinary skill in the art can completely understand how to implement the technical solution disclosed herein.

A person having ordinary skill in the art will understand that embodiments of the present disclosure may be provided as methods, systems, or computer program products. Accordingly, the present disclosure may take the form of an entirely hardware embodiment, an entirely software embodiment, or an embodiment that combines software and hardware aspects. Further, the present disclosure may take the form of a computer program product embodied on one or more computer-usable non-transitory storage media (including but not limited to a disk memory, a CD-ROM, an optical storage device, etc.) having computer-usable program code embodied therein.

The present disclosure is described with reference to flow charts and/or block diagrams of methods, devices (systems), and computer program products according to the embodiments of the present disclosure. It shall be understood that the functions specified in one or more processes in the flow chart illustrations and/or in one block or blocks in the block diagrams can be implemented by computer program instructions. These computer program instructions may be provided to the processor of a general-purpose computer, a special-purpose computer, an embedded processor, or other programmable data processing devices to produce a machine. In this way, the commands executed by the processor of the computer or other programmable data processing devices generate a device for implementing the functions specified in one or more processes in the flow chart and/or one or more blocks in the block diagram.

These computer program instructions may also be stored in a computer-readable memory that may guide a computer or other programmable data processing devices to work in a specific manner. In this way, the commands stored in the computer-readable memory generate an article of manufacturing including the command device. The command device implements the functions specified in one or more processes in the flow chart and/or one or more blocks in the block diagram.

These computer program instructions may also be loaded onto a computer or other programmable data processing devices, so that a series of operation steps may be executed on the computer or other programmable devices to generate processing of computer implementation. As such, the commands executed on the computer or other programmable devices provide steps for implementing the functions specified in one or more processes in the flow chart and/or one or more blocks in the block diagram.

Although some specific embodiments of the present disclosure are described in detail by way of examples, a person having ordinary skill in the art should know that the above examples are provided for illustration only and not for the purpose of limiting the scope of the present disclosure. A person having ordinary skill in the art shall understand that the above embodiments may be modified or some technical features may be equivalently replaced without departing from the scope and spirit of the present disclosure. The scope of the present disclosure is defined by the appended claims.

1. A plant information display method, comprising:
in response to a user request, acquiring plant information of a plant;
according to at least one of a user attribute and a plant attribute, determining a content module that needs to be displayed; and
displaying the content module, so as to display the plant information corresponding to the content module,
wherein one or a plurality of content modules are provided, and when a plurality of content modules are provided, each content module corresponds to a portion of the plant information, a display sequence between each content module can be adjusted, and the display sequence comprises at least one of a position sequence and a time sequence of the content modules during a display process.

2. The method according to claim 1, wherein the according to at least one of the user attribute and the plant attribute, determining the content module that needs to be displayed comprises:
determining a content module suggested for display according to at least one of the user attribute and the plant attribute;
displaying to a user a name of the content module suggested for display, wherein the name is used to indicate a content topic of the content module; and
in response to a user's selection operation on the name, determining the content module selected by the user as the content module that needs to be displayed.

3. The method according to claim 1, wherein a plurality of content modules are provided, and the method further comprises:
according to at least one of the user attribute and the plant attribute, determining the display sequence; and
displaying the content modules according to the display sequence.

4. The method according to claim 3, wherein
according to at least one of the user attribute and the plant attribute, an importance level of the content module that needs to be displayed is determined,
the display sequence is determined according to the importance level, and
the content module that needs to be displayed is displayed according to the display sequence.

5. The method according to claim 1, before displaying the content module, further comprising:
according to at least one of the user attribute and the plant attribute, determining an importance level of the content module that needs to be displayed; and
determining a size of a display region corresponding to the content module that needs to be displayed according to the importance level.

6. The method according to claim 1, before displaying the content module, the method further comprising: generating a label according to the plant information corresponding to the content module; and
displaying the content module comprising displaying the label.

7. The method according to claim 1, wherein
the user attribute comprises at least one of skill level, identification level, address, scenario, demand, and nationality.

8. The method according to claim 1, further comprising:
determining the user attribute based on at least one of an interactive questionnaire and historical operation data of the user recorded by the system.

9. The method according to claim 1, wherein
the plant attribute comprises at least one of plant type, species, Plant Developmental Stages, state, care, location, and crop type.

10. The method according to claim 1, further comprising:
determining the content module that needs to be displayed according to at least one of the user attribute and the plant attribute and an environment attribute,
wherein the environmental attribute comprises at least one of time information, climate information of a location of the plant, temperature information, humidity information, and illumination information.

11. The method according to claim 2, wherein the plant attribute comprises species, and
the content module suggested for display is determined according to the species.

12. The method according to claim 2, further comprising:
when the user does not perform a selection operation on the name, determining the content module suggested for display as the content module that needs to be displayed.

13. The method according to claim 1, wherein
the user request comprises at least one of an identification request and a search request.

14. The method according to claim 2, wherein
the content module suggested for display comprises at least one of a basic-type content module, a feature-type content module, and an interest-type content module,
the basic-type content module comprises at least one of other name, species, description, images, and characteristics,
the feature-type content module comprises at least one of toxic, whether it is an invasive species, whether it is pet-friendly, whether it attracts animals, and whether it is a weed, and
the interest-type content module comprises at least one of care, name story, use, related poems, interesting facts, and share.

15. (canceled)

16. (canceled)

17. (canceled)

18. (canceled)

19. (canceled)

20. (canceled)

21. (canceled)

22. (canceled)

23. A plant information display method, comprising:
acquiring plant information of a target plant, wherein the plant information comprises one or a plurality of content modules divided according to information content, and each content module has a name indicating a content topic of the content module;
displaying the names of the one or plurality of content modules in a first region of a display page; and
in response to receiving an operation associated with a first content module among the one or plurality of content modules, displaying information comprised in the first content module in the display page.

24. The method according to claim 23, wherein each content module also has one or a plurality of labels associated with the information content of the content module, and the method further comprises:
displaying all labels corresponding to the one or plurality of content modules in a second region of the display page, wherein the second region is arranged in a higher priority position in the display page than the first region.

25. The method according to claim 24, further comprising:
in response to receiving an operation associated with a first label among the labels, determining whether all labels included in the content module corresponding to the first label are operated; and
in response to all labels of the content module corresponding to the first label being operated, closing the display of the corresponding content module in the first region.

26. The method according to claim 23, wherein a second content module among the one or plurality of content modules comprises a plurality of submodules divided according to information content, each submodule has a name indicating a content topic of the submodule, and the method further comprises:
displaying the names of the plurality of submodules in a region associated with the second content module in the first region; and
in response to receiving an operation associated with a first submodule among the plurality of submodules, displaying information comprised in the first submodule in the display page.

27. The method according to claim 23, further comprising:
according to at least one of a user attribute and a plant attribute, acquiring the plant information of the target plant.

28. The method according to claim 27, further comprising:
pre-establishing a plant information database, wherein the database stores plant information of a plurality of plants, the plant information of each plant comprises a plurality of content modules divided according to information content, and each content module has a name indicating a content topic of the content module and one or a plurality of labels associated with the information content of the content module;
retrieving the plant information of the target plant from the database according to species of the target plant;
determining one or a plurality of target labels according to at least one of other plant attributes of the target plant and the user attribute; and
according to the one or plurality of target labels, acquiring one or a plurality content modules corresponding to the one or plurality target labels from the plant information of the plant, so as to acquire the plant information of the target plant.

29. (canceled)

30. (canceled)

31. (canceled)

32. A plant information display apparatus, comprising:
an acquisition module, configured to acquire plant information of a plant in response to a user request;
a determination module, configured to determine a content module that needs to be displayed according to at least one of a user attribute and a plant attribute; and
a display module, configured to display the content module, so as to display the plant information corresponding to the content module,
wherein one or a plurality of content modules are provided, each content module corresponds to a portion of the plant information, and when a plurality of content modules are provided, a display sequence between each content module can be adjusted.

33. (canceled)

34. A plant information display apparatus, comprising:
a memory; and
a processor coupled to the memory and configured to execute the method according to claim 1 based on a command stored in the memory.

35. (canceled)

36. (canceled)

37. A plant information display apparatus, comprising:
a memory; and
a processor coupled to the memory and configured to execute the method according to claim 23 based on a command stored in the memory.
